(19) United States
(12) Patent Application Publication
(10) Pub. No.: US 2004/0078693 A1
(43) Pub. Date: Apr. 22, 2004

(54) Software testing

(76) Inventor: Stephen Richard Kellett, Cambridgeshire (GB)

Correspondence Address: INDIANAPOLIS OFFICE 27879, BRINKS HOFER GILSON & LIONE, ONE INDIANA SQUARE, SUITE 1600, INDIANAPOLIS, IN, 46204-2033, US

(21) Appl. No.: 10/395,632

(22) Filed: Mar. 24, 2003

(30) Foreign Application Priority Data
Mar. 22, 2002 (GB) GB 0206761.9

(51) Int. Cl. G06F 11/00

(52) U.S. Cl. 714/38

(57) ABSTRACT

Apparatus, method and software for testing software, the apparatus comprising display means, for example a VDU, and display control means which is adapted to compose an image of a log report, the log report comprising details of events which have occurred when the software under test, or a portion thereof, has been run, and in particular details (15, 24, 25, 28) of faults, inefficient software operations and other event data, a user of the apparatus being able to arrange that indicators (L1, L2, L3, L4, L6) are inserted into the displayed log report at boundaries between particular actions performed by the software under test, and the user is able to restrict display of the log report to that part which is between two particular indicators. The invention is of particular use in locating faults when debugging software.

### FIELD OF THE INVENTION

The present invention relates to methods and apparatus for testing software particularly, but not exclusively, to the detection of memory-related errors such as memory leak, and memory corruption, which may arise when an application computer program or device driver is executed.

### BACKGROUND TO THE INVENTION

It can be an extremely time-consuming and tedious operation to examine, without the use of a software-testing system, newly-created and existing software in order to detect faults and/or inefficient routines, such as routines which create bottlenecks in processing, or routines which corrupt data.

It is generally essential to locate and correct the cause of ‘memory leak’ which is the term applied to the situation in which memory is allocated for use by a software action(s), but once the action(s) has/have been executed not all of the allocated memory is freed for subsequent use. The effect of running software which incorporates memory leak faults is to progressively reduce the available memory so that sooner or later the program cannot run.

The action by the software may be:

1) A routine.

2) A routine that calls many other routines.

3) An action from the users perspective (such as formatting a document, or calculating a spreadsheet, or extruding a boss in a 3D CAD program).

Other types of errors which should desirably be located in testing software are, for example, variable initialisation errors, pointer errors, string manipulation errors, buffer underflow errors, buffer overflow errors.

Various software products have been developed to assist in debugging of software. For example, the PURIFY™ and QUANTIFY™ products of Rational (at www.rational.com), the INSURE⁺⁺™ product of Parasoft (at www.parasoft.com) and the BOUNDSCHECKER™ product of Compuware Corporation (at www.numega.com).

Such software products enable the software engineer to locate software bugs as various portions of the program under test are executed. The products provide various forms of log reports on a VDU display which can be used by the software engineer to take decisions on correcting/modifying the software under test.

We have appreciated that the form of such log reports can be significantly improved essentially by enabling the software engineer to record in association with the log of event data one or more events in the running of the software which signify which portion of the software is being tested.

Current log reports are generally displayed in the form of a chronological list of events and error types alongside the identity of the line of software in which the error resides. Whilst such reports enable specific errors to be corrected they do not generally display to the engineer any record of which portion of the software is being tested, so it is necessary for the engineer to maintain a separate manual record of which portions of the software have been/are being tested. One reason why the current log reports are not as helpful as we desire is, of course, that a multiplicity of software actions/routines will make use, often repeatedly, of the same line of software code, and the mere presentation in the report of the lines of software code in which errors have been found is, in our view, a problem.

### SUMMARY OF THE INVENTION

According to one aspect of the present invention, we provide apparatus for testing software comprising display means and display control means adapted to compose an image of a log report of events in response to the output of a log creation means which is adapted to compile a log comprising pre-determined categories of events representative of at least one of a fault, an inefficient software operation and event data on execution of software under test by the apparatus, indicator insertion means responsive to a manual input means for enabling a user of the apparatus to associate at least one indicator with the log prior to or during execution of the software to indicate in the displayed log report a boundary between different actions performed by the software under test, the apparatus being configured to implement at least one of (a) the display control means being responsive to both the log creation means and the indicator insertion means, and (b) the log creation means being responsive to fault outputs from fault detection means and to the indicator insertion means, whereby said apparatus is capable of allowing a user to perform at least one of (i) displaying that part of the log report which is between two particular indicators in response to respective references to the particular indicators input by the user and (ii) searching for data in the log report which is located between two particular indicators.

Preferably the log also records non-error events and data relating to non-inefficient events.

Thus the displayed log report can be provided with one or more indicators to indicate to the tester, for example, the start and end of an action by the software.

However, it should be appreciated that when the user chooses to display only events occurring during one action performed by the software, it may not be necessary to indicate in the display the actual start and end of that action, the display simply showing all of the relevant types of events occurring during the performance of that action. So when the display is in the form of a vertically displayed chronological list of events, the top and bottom margins of the displayed list then constitute indicators of the portion of software under test.

The indicator preferably comprises a boundary line, band, (or surface in the case of a three dimensional log report) extending across the display.

For example, when the display is in the form of a list of horizontally extending lines of data, each line representing a report on an individual action taken by the software, then the line or band is preferably a horizontal line or band.

Most preferably the indicator is a line or band which is superimposed upon the displayed log report, preferably in a different colour to the background. Alternatively the text of a line, or column in the case of a display extending in chronological order from the left to right, could be in a different colour to the background or typestyle, or a marker (such as an arrow) could be provided in the margin of a log in tabular form.

When the indicators take the form of a line or band, the display may also comprise a key to the indicator bands or lines, thereby minimising the additional identificatory text associated with the line or band.

The apparatus preferably comprises analysis means to enable the tester to conduct further analyses on the recorded events that are disposed between two indicators. For example, the record may be further analysed to locate inefficient routines.

According to a second aspect of the invention we provide a method of testing computer software comprising executing a portion of software under test, during that execution compiling a log comprising at least one of (i) event data, (ii) pre-determined categories of events representative of a fault and (iii) an inefficient software operation, manually associating with the log, as the log is being compiled, one or more indicators to indicate in a displayed log report the portion of the software under test, and the method further comprising at least one of (a) inputting respective references to two indicators so as to display that part of the log report which is between said two indicators, and (b) searching for data in the log report which is between two particular indicators.

The inventive method may be seen as a method of selecting which of the event data held in the log is to be displayed to a user in the log report (subject to which event data the user determines is to be included in the log).

According to a third aspect of the invention we provide computer program testing software encoded on a computer readable medium, the software being configured to allow implementation of the method of testing in accordance with the second aspect of the invention.

One or more indicators may be automatically inserted into or associated with the log by the API (application programming interface). Thus, the API may be arranged to insert an indicator into the log at the start of running a portion of a software action, and/or another indicator may be inserted into the log by the API at the end of the software action.

Thus the API is used to call a function that initiates the association with the log of an indicator.

The various aspects of the invention will now be further described, by way of example only, with reference to the accompanying drawings, in which:

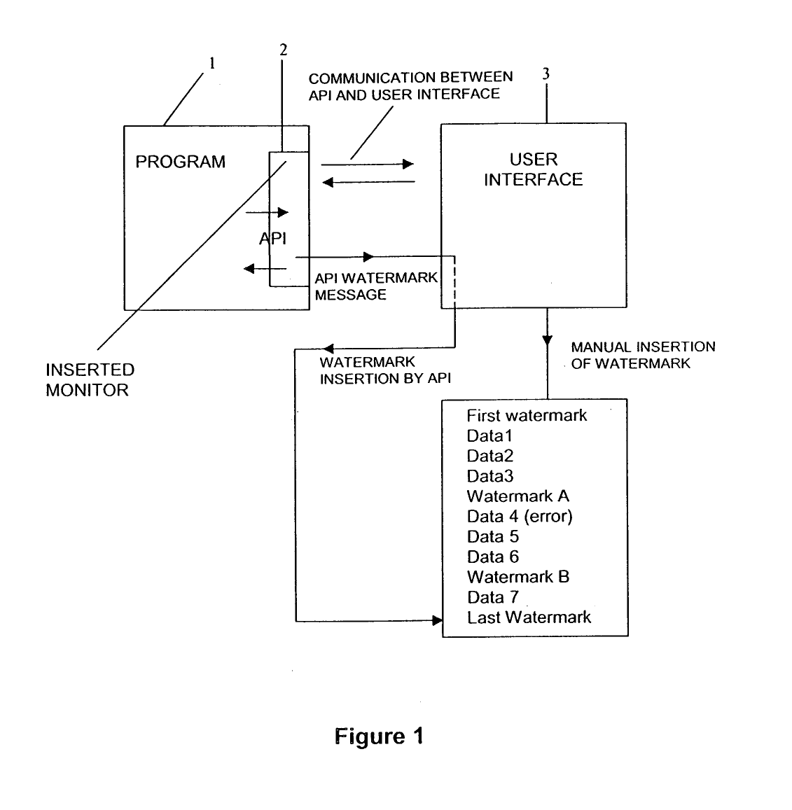

FIG. 1 is a schematic of a software testing apparatus in accordance with the invention being used to test a program;

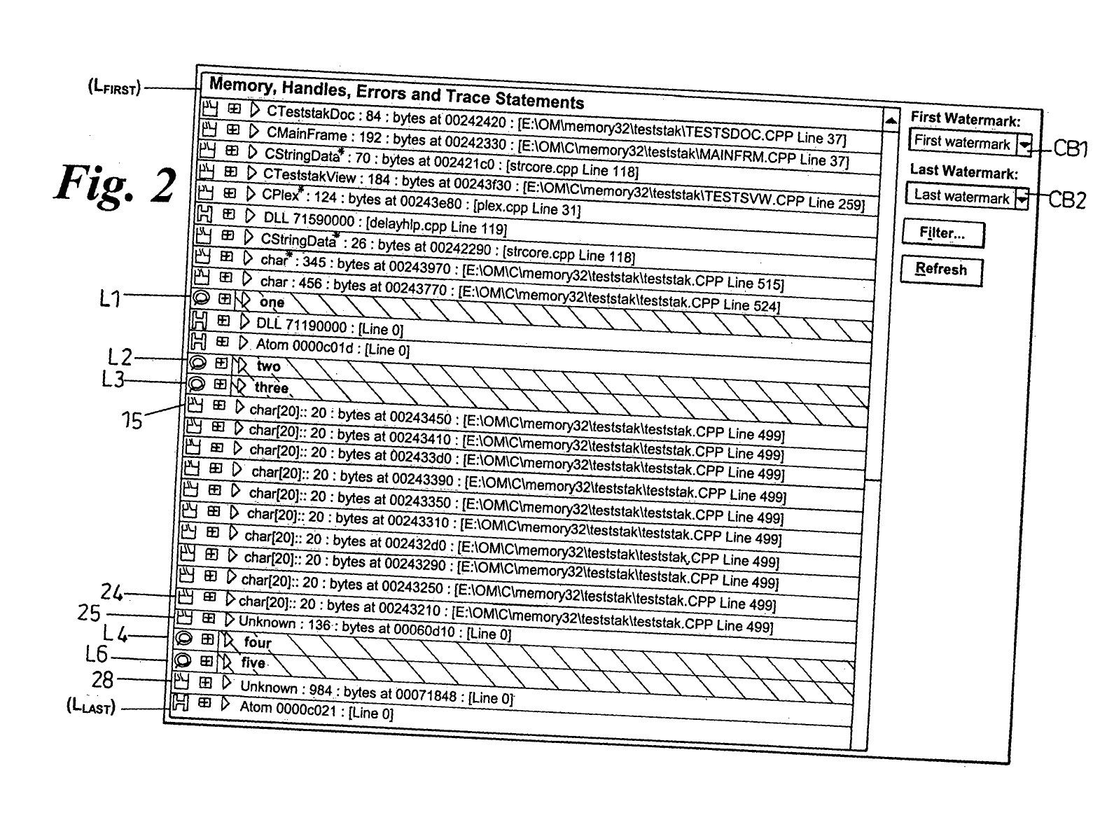

FIG. 2 is a display of a log of memory, handles, errors and trace statements produced in testing a portion of a program, and incorporating various inserted watermarks; and

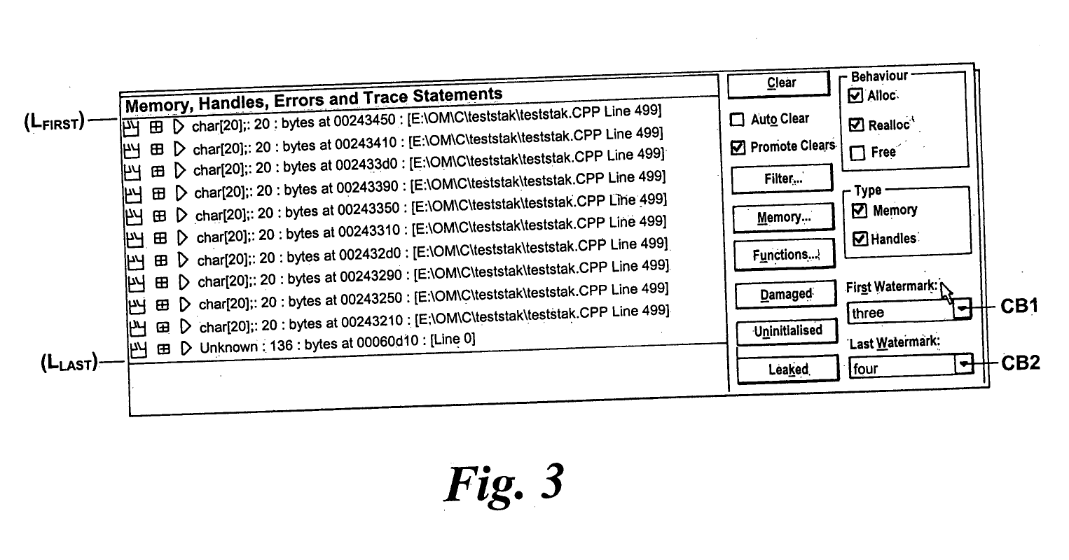

FIG. 3 is a display of a log, similar to FIG. 2, and produced in testing the same program portion as that being tested for FIG. 2, but in which the displayed portion of the log has been confined to that between watermarks numbered three and four.

With reference to FIG. 1, a program 1 under test is monitored by use of an inserted software monitor 2 which enables a user interface 3 to control running of the program 1 and to receive information on the computational steps caused by the running of the program. The user interface 3 can take the form of a personal computer (PC) running a software testing application which comprises software functions to perform the invention.

In particular the software testing application enables the user, a software tester, to incorporate boundary lines in a displayed log report, which I term ‘watermarks’ (by analogy with a plimsoll line on a ship) to delineate different sections of a log of data representative of the chronological test results produced in running of a program portion. The log of event data created by the software monitor 2 comprises data about error operations and non-error operations. The user can choose to insert a selected number of watermarks to designate the commencement/completion of different sections of the program portion of interest.

The user may assign two watermarks to the beginning and end of a section using the API so that when the program is run the log report of events which occur during running of the program between those two watermarks will display at least those events.

It will be appreciated however that in some circumstances it may be preferable to manually work through the program, or sections of the program of interest, so as to determine where the watermarks will be inserted when the program is run.

The events displayed can, as previously discussed, take various forms. In the illustrated examples of FIG. 2 allocations of memory are displayed, such as in lines 15 to 24, as well as errors in allocation and de-allocation, such as the errors indicated of lines 25 and 28. (In practice error lines such as lines 25 and 28 are desirably displayed in a different colour from lines such as 15 to 24 that do not indicate an error and the watermarks are displayed in a yet different colour.)

A watermark L1 has been manually initiated at log line L1 in the form of a coloured band. It will be appreciated that the watermark L1 will generally only exist in the form of an instruction prior to actual running of the program portion, and that the composite display showing the watermark L1 inserted into the log report of program actions will not be composed in a display control until the program portion has been run to generate the event lines coming immediately before the watermark L1.

Thus it will be appreciated that most of the horizontal lines in the display of FIG. 2 correspond to individual events in the execution of a portion of the software under test, and the inserted watermarks numbered ‘one’, ‘two’, ‘three’, ‘four’ and ‘five’ are additional lines of data that are associated with or incorporated into the log as additional lines of data.

In FIG. 2, a notional first watermark is indicated at L_{FIRST} and simply constitutes that start of the display, and accordingly, does not have to be displayed as such as an extra line of data, but it will be appreciated that it could be displayed as an actual band, similar to watermark L1 if desired.

Similarly the last watermark is also a notional watermark but is indicated in FIG. 2 as L_{LAST}. The last watermark is similarly not displayed in the display. Nevertheless, first and last watermarks L_{FIRST} and L_{LAST} do exist in association with the data collected in order to determine what data is to be displayed on screen.

FIG. 3 shows the displayed log report when the user interface controls CB1 and CB2 (known as Combo Boxes in Microsoft™ Windows™ terminology) have been set to watermark three and watermark four, these being the names of watermarks that the program tester has associated with specific program boundaries in the program.

Since only two watermarks are used in producing the report of FIG. 1, these do not need to be displayed, but are indicated at L_{FIRST} and L_{LAST} for explanatory purposes only.

In a modified embodiment of the invention the user is able to search for particular events which occurred between two watermarks. In such an embodiment a user would enter the references of two watermarks of interest and would then be able to enter details of the type of event, or of a specific event or events, he wishes to locate which occurred between said two watermarks. The user would then be presented with details of the events which match the search criteria, either highlighted in the relevant portion of the log report, or listed separately.

1. Apparatus for testing software comprising display means and display control means adapted to compose an image of a log report of events in response to the output of a log creation means which is adapted to compile a log comprising pre-determined categories of events representative of at least one of a fault, an inefficient software operation and event data on execution of software under test by the apparatus, indicator insertion means responsive to a manual input means for enabling a user of the apparatus to associate at least one indicator with the log prior to or during execution of the software to indicate in the displayed log report a boundary between different actions performed by the software under test, the apparatus being configured to implement at least one of (a) the display control means being responsive to both the log creation means and the indicator insertion means, and (b) the log creation means being responsive to fault outputs from fault detection means and to the indicator insertion means, whereby said apparatus is capable of allowing a user to perform at least one of (i) displaying that part of the log report which is between two particular indicators in response to respective references to the particular indicators input by the user and (ii) searching for data in the log report which is located between two particular indicators.

2. Apparatus as claimed in claim 1 in which the log also records non-error events and data relating to non-inefficient events.

3. Apparatus as claimed in claim 1 in which the displayed log report is in the form of a vertically displayed chronological list of events.

4. Apparatus as claimed in claim 1 in which the at least one indicator comprises at least one of a boundary line, a band and a surface extending across the displayed log report.

5. Apparatus as claimed in claim 1 in which the displayed log report is in the form of a list of horizontally extending lines of data, each line representing a report on an individual action taken by the software, and the at least one indicator is at least one of a horizontal line and a band.

6. Apparatus as claimed in claim 1 in which the indicator is at least one of a line or band which is superimposed upon the displayed log report.

7. Apparatus as claimed in claim 6 in which the at least one indicator is displayed in a different colour to the background.

8. Apparatus as claimed in claim 5 in which text of a line is in a different colour to the background or typestyle.

9. Apparatus as claimed in claim 1 in which an arrow representative of an indicator is provided in the margin of a log report in tabular form.

10. Apparatus as claimed in claim 1 in which where the at least one indicator is in the form of at least one of a band or a line, the displayed log report may be provided with a key to the at least one indicator.

11. Apparatus as claimed in claim 1 which comprises analysis means to enable the user to conduct further analyses on recorded events between two particular indicators.

12. A method of testing computer software comprising executing a portion of software under test, during that execution compiling a log comprising at least one of (i) event data, (ii) pre-determined categories of events representative of a fault and (iii) an inefficient software operation, manually associating with the log, as the log is being compiled, one or more indicators to indicate in a displayed log report the portion of the software under test, and the method further comprising at least one of (a) inputting respective references to two indicators so as to display that part of the log report which is between said two indicators, and (b) searching for data in the log report which is between two particular indicators.

13. Computer program testing software encoded on a computer readable medium, the software, when loaded onto a data processor, being configured to allow implementation of the method of testing in accordance with claim 12.
